(19) United States
(12) Patent Application Publication
(10) Pub. No.: US 2014/0063711 A1
(43) Pub. Date: Mar. 6, 2014

(54) SIGNAL CONVERSION ELECTRICAL CONNECTOR

(71) Applicant: Yi-Fang CHUANG, New Taipei City (TW)

(72) Inventor: Yi-Fang CHUANG, New Taipei City (TW)

(21) Appl. No.: 13/962,640

(22) Filed: Aug. 8, 2013

(30) Foreign Application Priority Data
Aug. 29, 2012 (TW) 101216607

(51) Int. Cl. G06F 3/147

(52) U.S. Cl. CPC G06F 3/147
USPC 361/679.4

(57) ABSTRACT

A signal conversion electrical connector that electrically connects with the electronic device and has: an insulated base, which has a body thereon, the front end of the body has a retaining wall, the retaining wall outwardly extends to form a tongue member; a pin set, which is formed by a plurality of conductive pins, each of the conductive pins goes through the retaining wall to connect with the tongue member; and a PCB (printed circuit board), which electrically connects with the pin set and has a signal conversion unit and a plurality of conductive terminals; wherein the signal conversion unit transforms DisplayPort signals from the electronic device to HDMI signals for outputting

### BACKGROUND OF THE INVENTION

1. Field of the Invention

The present invention generally relates to an electrical connector, more particularly to an electrical connector that transforms DisplayPort signals to HDMI signals for outputting.

2. Description of the Related Art

With the popularity of liquid crystal display, and the digital signal transmission video and audio applications has been extended to multimedia player, projector, game consoles, digital cameras and other consumer electronic products, and are no longer confined to the TV and peripheral products. Presently, audio and video digital signal transmission interface is mostly using High Definition Multimedia Interface (HDMI) as the audio and video digital signal transmission.

Video Standards Association (VESA) studies specifications and weaknesses of HDMI interface to develop a DisplayPort interface to replace the HDMI interface. This also makes that the HDMI interface and the DisplayPort interface are now the most commonly used in audio and video transmission interface. The HDMI interface and the DisplayPort interface are very different in specifications and features as well. The DisplayPort interface can be applied by way of two-way audio transmission, and it is very suitable for video conference, Internet telephony and other applications. The top drawback of the HDMI interface is to proceed external connection of one-to-one and Box-to-Box) via the same HDMI interface. That is, a single HDMI interface to connect to multiple monitors may not work.

Further, the DisplayPort interface supports internal connection to support the internal connection of chip-to-chip (Chip-to-Chip). Therefore, through computer graphics chipset, or ICs in monitors and televisions, a device is able to support multiple monitors. Hence, such technology is not only very suitable for business or commercial purposes, but consistent with the concept of digital home. In performance of audio-visual effects, HDMI interface is able to support 48 bit (3 colors, each 12-bit), and the DisplayPort interface supports only up to 30 bit (3 colors, each 10-bit), such difference makes HDMI interface be more nature and accurate on color display. For audio specifications, HDMI interface additionally supports Dolby TrueHD and DTS-HD Master Audio, and other kinds of non-distortion audio, but DisplayPort interface on the actual audio standards is less progress.

Differences between aforesaid two specifications are not only to know DisplayPort interface has the advantages of “one-to-many” and “two-way audio transmission”, but also good to enterprise operations that focus on computer technology as a center thereof. HDMI interface is able to provide users a better video and audio effect, so it is very suitable for consumer electronics market. It is because of the DisplayPort interface being not beyond the HDMI interface, so how to make an electronic device that outputs DisplayPort signals being capable of outputting HDMI signals is an important issue for the present invention discussing to.

### SUMMARY OF THE INVENTION

The main objective of the present invention is to solve the shortcomings of related arts. The present invention installs an electrical connector that can transform DisplayPort signals to HDMI signals on an electronic device that can output DisplayPort signals.

To approach above objective, the present invention provides a signal conversion electrical connector that electrically connects with the electronic device and has:

an insulated base, which has a body thereon, the front end of the body has a retaining wall, the retaining wall outwardly extends to form a tongue member;

a pin set, which is formed by a plurality of conductive pins, each of the conductive pins goes through the retaining wall to connect with the tongue member;

a PCB (printed circuit board), which electrically connects with the pin set and has a signal conversion unit and a plurality of conductive terminals;

wherein the signal conversion unit transforms DisplayPort signals from the electronic device to HDMI signals for outputting;

wherein the retaining wall outwardly extends to form a chassis;

wherein the top surface and the bottom surface of the tongue member are disposed a plurality of grooves, the grooves are corresponding to a plurality of holes, through the holes the pin set going through, so that the pin set are assembled in the grooves;

wherein the body has two lateral plates corresponding to each other, each of the rear ends of the two lateral plates has a bump, the two bumps are corresponding to each other, one end of the bump extends along with the surface of the lateral plate to form a bolt, the two inner lateral walls have a pair of sunken assembling portions;

wherein the conductive pin has a latching portion with two lateral tooth shapes, the front end of the latching portion extends to form a front pin and the rear end of the latching portion extends to form a rear pin, the front pin goes through the hole and inserts into the groove, the latching portion latches in the hole, the rear pin electrically connects with the electrical connecting point of the PCB;

wherein the PCB further has a plurality of front electrical connecting points, a plurality of rear through holes and a plurality of conductive terminals, the plurality of front electrical connecting points electrically connect with the signal conversion unit 31, the plurality of conductive terminals 33 go through the plurality of rear through holes and then electrically connect with the PCB and the signal conversion unit;

wherein the PCB further has a plurality of front electrical connecting points and a plurality of rear electrical connecting points, the front electrical connecting points and the rear electrical connecting points electrically connect with the signal conversion unit, the rear electrical connecting points electrically connect with the conductive terminals;

wherein the PCB further has a plurality of front penetrated holes and a plurality of rear penetrated holes, the front penetrated holes and the rear penetrated holes are for the pin set and the conductive terminals go through and then the pin set and the conductive terminals electrically connects with the PCB and the signal conversion unit;

wherein the signal conversion electrical connector further comprises an insulated bottom plate, the insulated bottom plate is an L-shape member and has a retaining portion at a front end thereof, the retaining portion has a loading portion in order to load the PCB, the loading portion has a plurality of penetrated holes for the conductive terminals of the PCB going through, and then conductive terminals electrically connect with the main board of the electronic device, each of two sides of the loading portion has a pair of connecting portions assembled with the assembling portions;

wherein the signal conversion electrical connector further comprises a metal case, the metal case has an interface at a front end thereof and a flap at a rear end thereof;

wherein each of a top surface and a bottom surface of the metal case has a plurality of flexible pieces, each of the two sides of the metal case is folded to form a lateral plate, the lateral plate extends to form a set of fixing legs;

wherein the lateral plate has a fillister, an open is formed between the lateral plate and the flap and communicates with the fillister, the open provides a connecting space for assembling with the bump and the bolt.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of conductive pins and a PCB (printed circuit board) of the electrical connector of the present invention;

FIG. 2 illustrates a schematic exploded and bottom view of the electrical connector of the present invention;

FIG. 3 illustrates a schematic assembled and external view of the electrical connector of the present invention;

FIG. 4 illustrates a schematic assembled and external view of another angle of the electrical connector of the present invention;

FIG. 5 illustrates a schematic assembled and sectional view of the electrical connector of the present invention;

FIG. 6 illustrates a schematic operation view of the electrical connector of the present invention;

FIG. 7 illustrates a schematic sectional view of FIG. 6;

FIG. 8 illustrates a schematic view of circuit blocks of the electrical connector of the present invention;

FIG. 9 illustrates a schematic view of another embodiment of the present invention; and

FIG. 10 illustrates a schematic view of another embodiment of the present invention.

### DETAILED DESCRIPTION OF THE INVENTION

Following preferred embodiments and figures will be described in detail so as to achieve aforesaid objects.

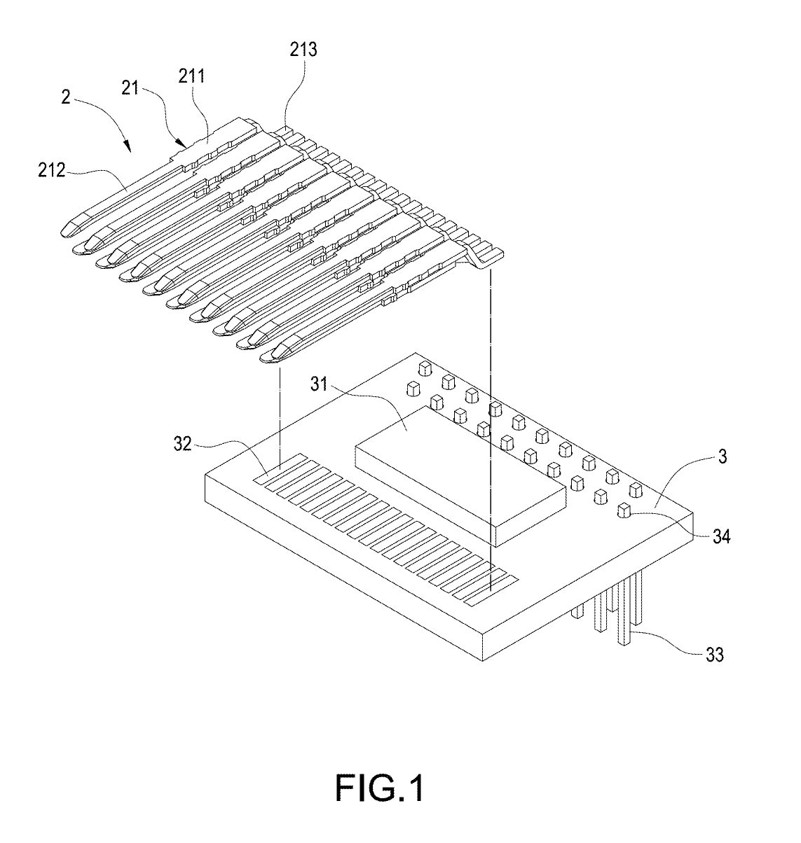

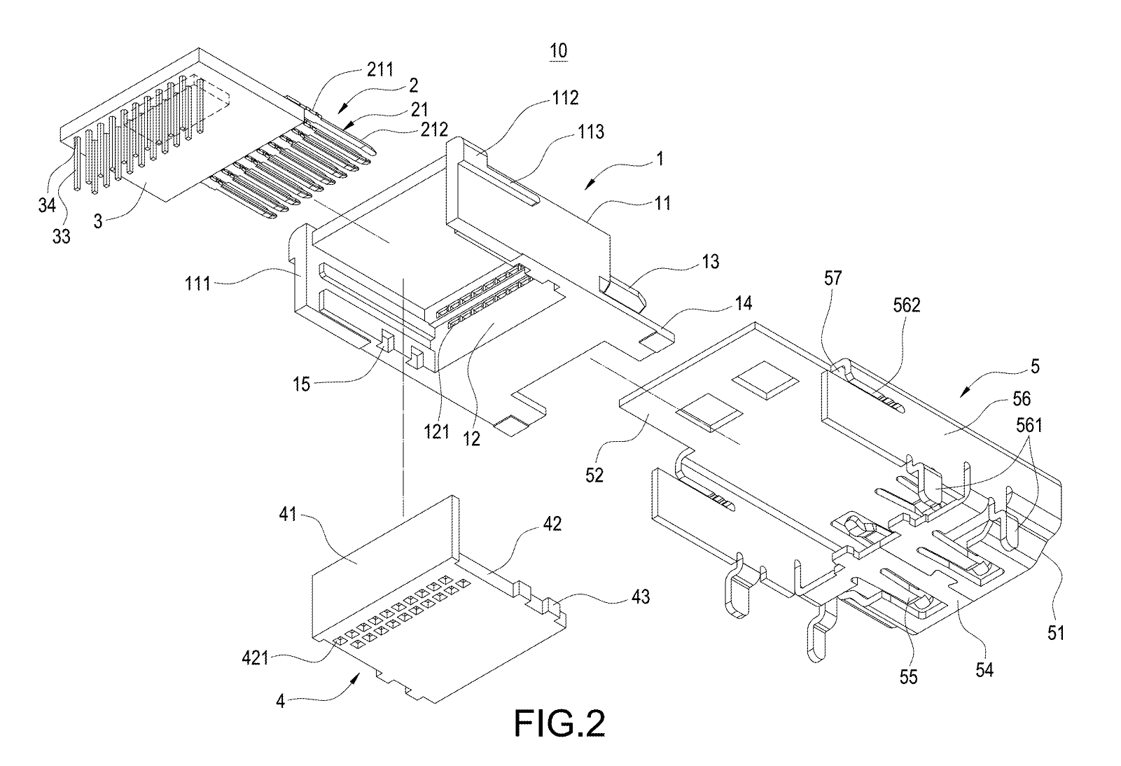

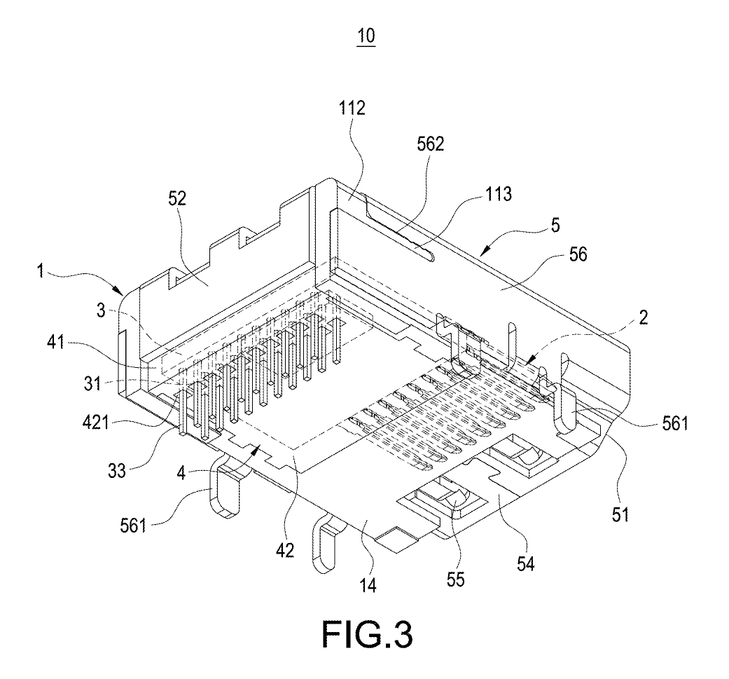

Please refer to FIG. 1 to FIG. 4, which illustrate a schematic view of conductive pins and a PCB (printed circuit board) of the electrical connector of the present invention, a schematic exploded and bottom view of the electrical connector of the present invention, a schematic assembled and external view of the electrical connector of the present invention, and a schematic assembled and external view of another angle of the electrical connector of the present invention. As shown in figure, the signal conversion electrical connector 10 has an insulated base 1, a pin set 2, a PCB (printed circuit board) 3, an insulated bottom plate 4, and a metal case 5.

The insulated base 1 has a hollow body 11 thereon, the body 11 has a retaining wall 12, the retaining wall 12 outwardly extends to form a tongue member 13 and a chassis 14, the top surface and bottom surface of the tongue member 13 are disposed a plurality of grooves 131, as shown in FIG. 5, the grooves 131 are corresponding to a plurality of holes 121 of the retaining wall 12, the holes 121 are for conductive pins 21 going through, so that front pins 212 of the conductive pins 21 are able to insert into the grooves 131. Further, the body 11 has two lateral plates 111 corresponding to each other, each of the two sides of the lateral plate 111 has a bump 112, the two bumps 112 are corresponding to each other, one end of the bump 112 extends along with the surface of the lateral plate 111 to form a bolt 113 that is to connect with the metal case 5. Further, the two inner lateral walls of the body 11 has a pair of sunken assembling portions 15, each of the two sides of a loading portion 42 of the insulated bottom plate 4 has a pair of connecting portions 43 assembled to the assembling portions 15.

The conductive terminal set 2 is formed by the plurality of pins 21, the conductive pin 21 has a latching portion 211 with two lateral tooth shapes, the front end of the latching portion 211 extends to form a front pin 212 and the rear end of the latching portion 211 extends to form a rear pin 213, the front pin 212 goes through the hole 121 and inserts into the groove 131, the latching portion 211 latches in the hole 121, the rear pin 213 electrically connects with the electrical connecting point of the PCB 3.

The PCB 3 has a signal conversion unit 31, the signal conversion unit 31 transforms DisplayPort signals from an electronic device (not shown in figure) to HDMI signals for outputting. The PCB 3 has a plurality of front electrical connecting points 32, the plurality of front electrical connecting 32 electrically connects with the signal conversion unit 31. Further, The PCB 3 has a plurality of rear through holes 34, the plurality of conductive terminals 33 go through the plurality of rear through holes 34 and then electrically connect with the PCB 3, and then electrically connect with the signal conversion unit (31). After the conductive terminals 33 electrically connect with the main board of the electronic device, the DisplayPort signals from the main board will be sent to the signal conversion unit 31 and then be transformed, thereafter, the transformed signals may be delivered to the pin set 2.

The insulated bottom plate 4 is an L-shape member and has a retaining portion 41 a front end thereof, the retaining portion 41 has a loading portion 42 in order to load the PCB 3, the loading portion 42 has a plurality of penetrated holes 421 for the conductive terminals 33 of the PCB 3 going through and electrically connecting the main board (not shown in figure) of the electronic device. More, each of the two sides of the loading portion 42 has a pair of connecting portions 43 assembled to the assembling portions 15.

The metal case 5 is a hollow case and an interface 51 at a front end thereof and a flap 52 at a rear end thereof, the interface 51 is for the insertion of a male head (not shown in figure) of a transmission line. Further, each of a top surface 53 and a bottom surface 54 of the metal case 5 has a plurality of flexible pieces 55, each flexible piece 55 lets each male head (not shown in figure) inserting into the interface 51 firmly and electrically connect with the pin set 2. Further, each of the two sides of the metal case 5 is folded to form a lateral plate 56, the lateral plate 56 extends to form a set of fixing legs 561. The fixing leg 561 is able to firmly and electrically connect the metal case 5 and the ground of the main board of the electronic device. The lateral plate 56 has a fillister 562, an open 57 between the lateral plate 56 and the flap 52 communicates with the fillister 562, the open 57 provides a connecting space for assembling with the bump 112 and the bolt 113.

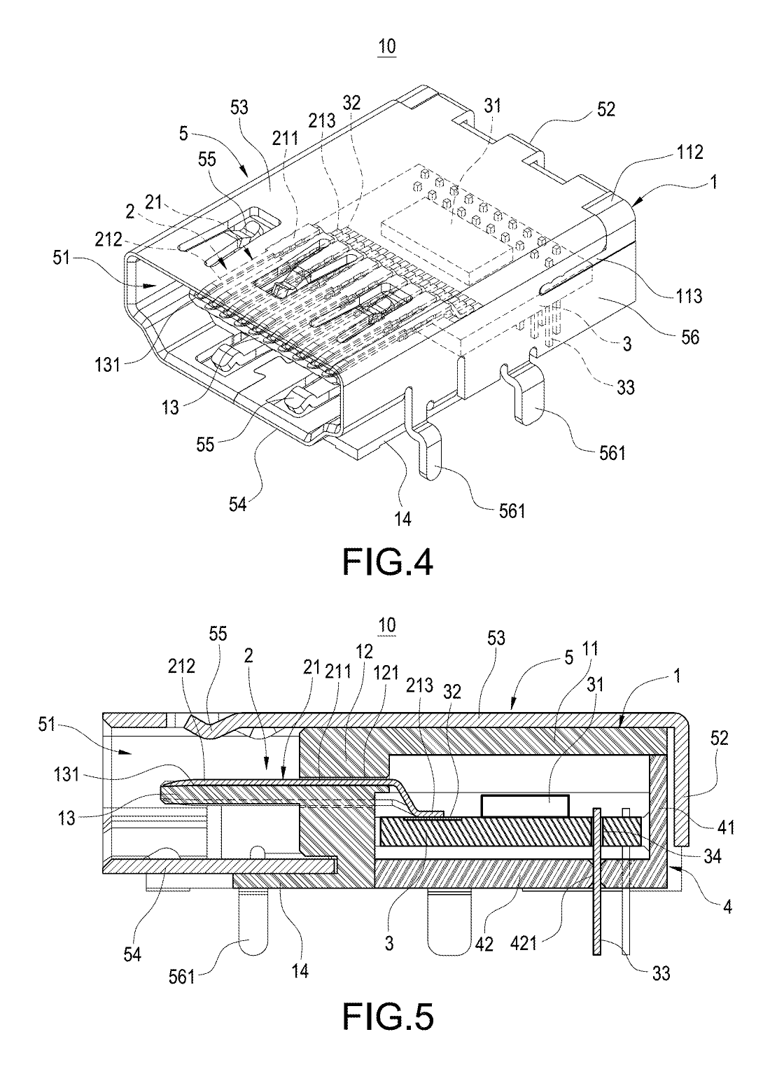

Please to FIG. 4 and FIG. 5, which illustrate a schematic assembled and external view of the electrical connector of the present invention and a schematic sectional view of the electrical connector of the present invention. As shown in figure, while the connector is in assembly, the front pins 212 of the conductive pin 21 go through the holes 121, the front pins 212 assemble with the grooves 131 of the tongue member 13, the rear pins 213 of the conductive pins 21 thus electrically connect with the front electrical connecting points 32 the PCB 3. The conductive terminals 33 of the PCB 3 go through the penetrated holes 421 of the insulated bottom plate 4, the connecting portions 43 of the two sides of the loading portion 42 assemble with the assembling portions 15 of the two sides of the inner wall of the body 11, the retaining portion 41 of the insulated bottom plate 4 is disposed at the rear end of the insulated base 1.

After assembling the insulated base 1, the pin set 2, the PCB 3, and the insulated bottom plate 4, the insulated base 1 is assembled in the metal case 5, the tongue member 13 of the front end of the insulated base 1 extends into the interface 51. Further, to fold the flap 52 at the rear end of the metal case 5, the insulated base 1 just can install in the metal case 5.

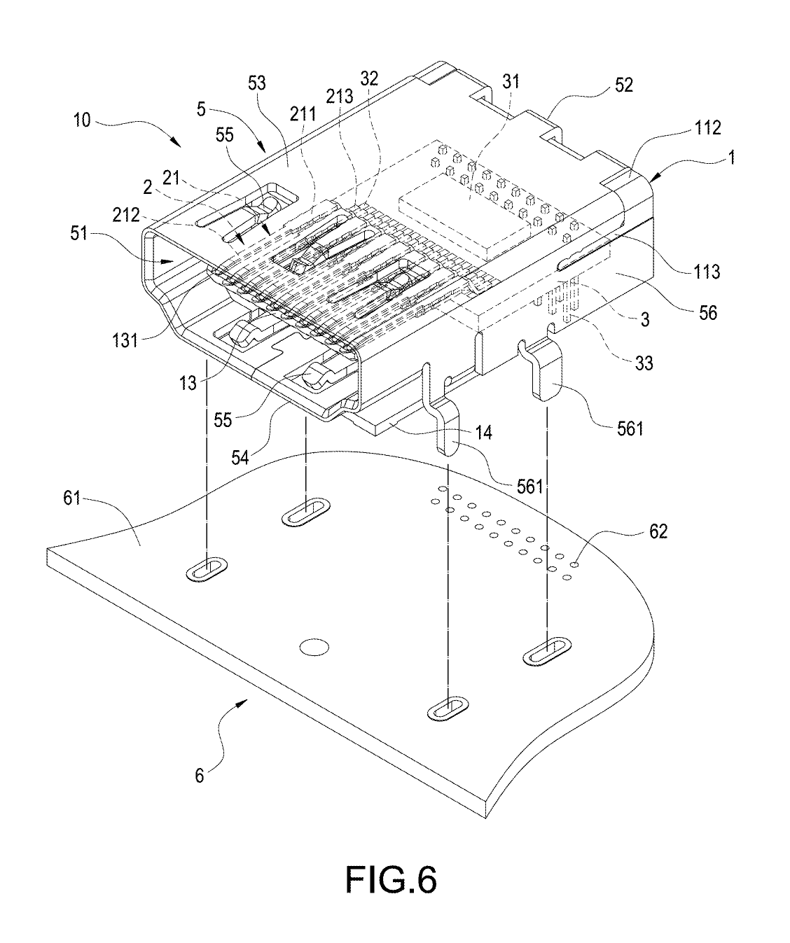

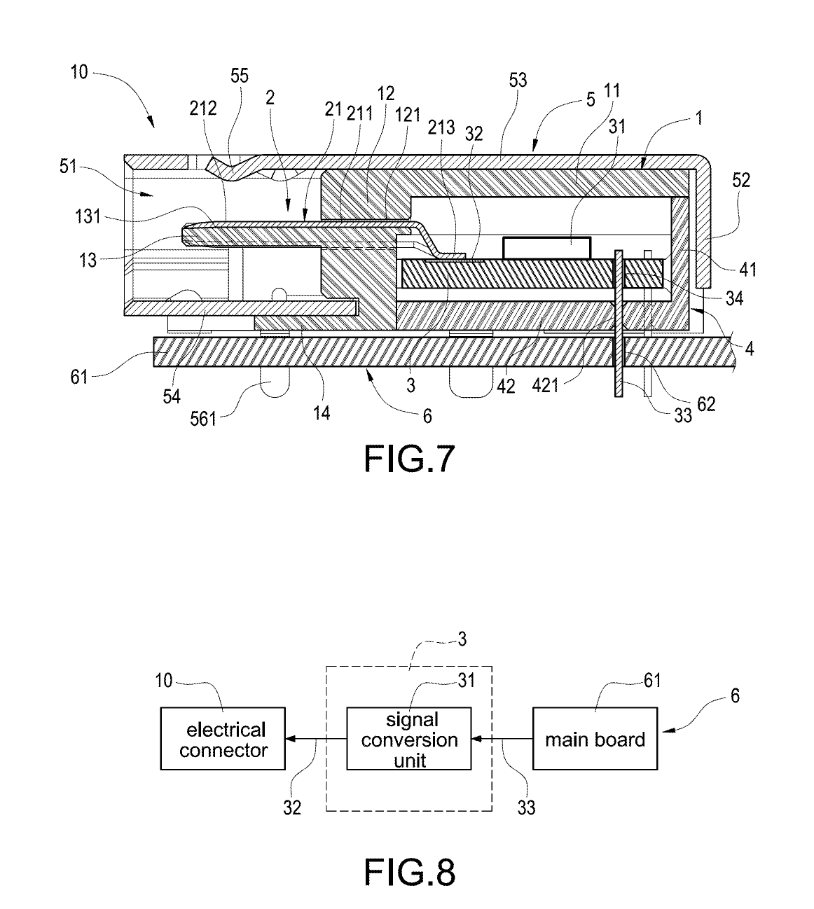

Please refer to FIG. 6, FIG. 7 and FIG. 8, which illustrate a schematic operation view of the electrical connector of the present invention, a schematic sectional view of FIG. 6, and a schematic view of circuit blocks of the electrical connector of the present invention. As shown in figure, while the connector is in operations, the conductive pins 33, extending to the external of the connector, penetrate through the penetrated holes 62 of the main printed circuit board 61 of the electronic device 6 in order to electrically connect with the PCB 3. The male head of the external HDMI transmission line (not shown in figure) also inserts into the interface 51, and after the male head electrically touches the front pin 212 of the conductive pin 21 of the tongue member 13, the DisplayPort signals from the main board 61 are delivered to the signal conversion unit 31 for transformation via the conductive terminal 33. After transforming the signals to the HDMI signals, the HDMI signals are sent to the pin set 2 via the front electrical connecting points 32, and then to the male head of the HDMI transmission line (not shown in figure). So that the HDMI signals are transmitted to another electronic device (not shown in figure) for display.

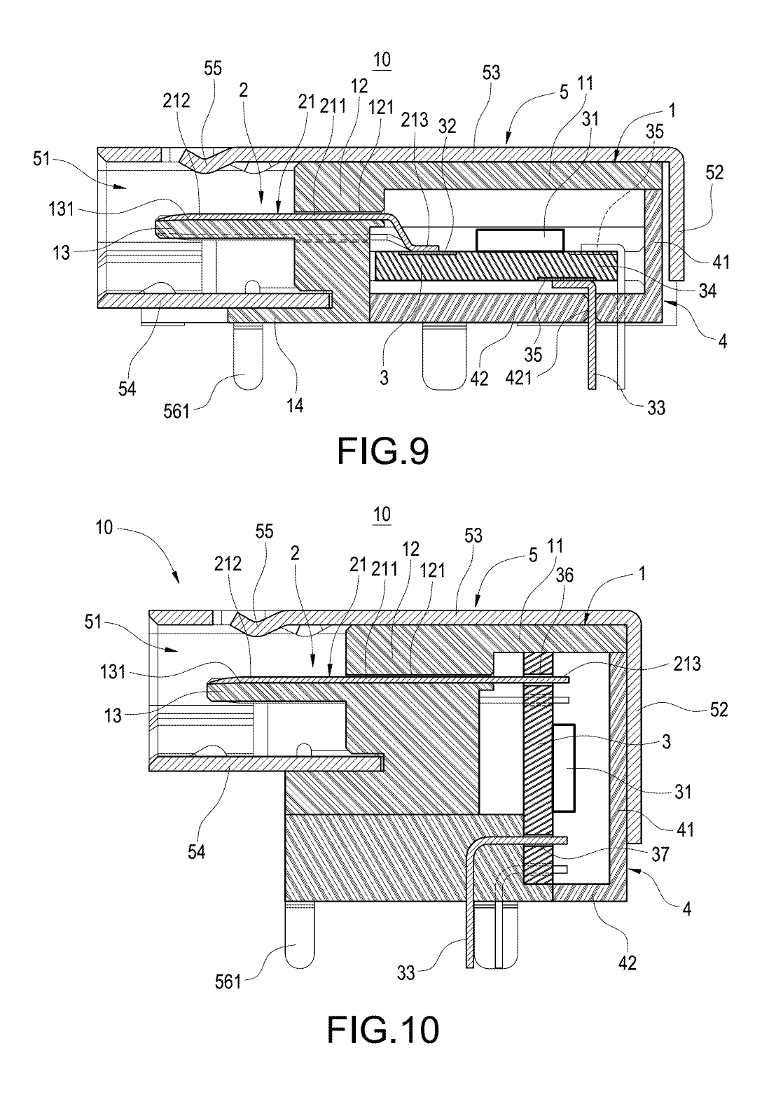

Please refer to FIG. 9, which illustrates a schematic view of another embodiment of the present invention. As shown in figure, the structure disclosed by the embodiment is almost the same as the structure disclosed by FIG. 1 to FIG. 8. The difference is that using SMT (surface mounting technology) to electrically connect the PCB 3 and the conductive terminals 33. That is, one end of the conductive terminal 33 is vertically folded to electrically connect the rear electrical connecting points of the front and back surfaces of the PCB 3. The conductive terminal 33 is through the penetrated hole 421 and then extends to the external of the electrical connector.

Please refer to FIG. 10, which illustrates a schematic view of another embodiment of the electrical connector of the present invention. As shown in figure, the electrical connector disclosed here is almost the same as the electrical connector disclosed by FIG. 1 to FIG. 7. The difference is that the PCB 3 is installed in the insulated base 1, the pin set 2 directly goes through the penetrated hole 36 of the PCB 3, and the PCB 3 and the signal conversion unit 31 are electrically connected to each other. Further, the conductive terminal 33 of the PCB 3 is vertically bent to go through the rear penetrated hole 37 and extends to the external of the insulated base 1 for electrical connection of a main board of an external electronic device (not shown in figure).

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A signal conversion electrical connector (10), which electrically connects with the main board (61) of an electronic device (6), comprising:
an insulated base (1), which has a body (11) thereon, the front end of the body (11) having a retaining wall (12), the retaining wall (12) outwardly extending to form a tongue member (13);
a pin set (2), which is formed by a plurality of conductive pins (21), each of the conductive pins (21) going through the retaining wall (12) to connect with the tongue member (13); and
a PCB (printed circuit board) (3), which electrically connects with the pin set (2) and has a signal conversion unit (31) and a plurality of conductive terminals (33);
wherein the signal conversion unit (31) transforms DisplayPort signals from the electronic device 6 to HDMI signals for outputting.

2. The signal conversion electrical connector (10) according to claim 1, wherein the retaining wall (12) outwardly extends to form a chassis (14).

3. The signal conversion electrical connector (10) according to claim 2, wherein the top surface and the bottom surface of the tongue member (13) are disposed a plurality of grooves (131), the grooves (131) being corresponding to a plurality of holes (121) through the holes (121) the pin set (2) going through, so that the pin set (2) are assembled in the grooves (31).

4. The signal conversion electrical connector (10) according to claim 3, wherein the body (11) has two lateral plates (111) corresponding to each other, each of the rear ends of the two lateral plates (111) having a bump (112), the two bumps (112) being corresponding to each other, one end of the bump (112) extending along with the surface of the lateral plate (111) to form a bolt (113), the two inner lateral walls having a pair of sunken assembling portions (15).

5. The signal conversion electrical connector (10) according to claim 4, wherein the conductive pin (21) has a latching portion (211) with two lateral tooth shapes, the front end of the latching portion (211) extending to form a front pin (212) and the rear end of the latching portion (211) extending to form a rear pin (213), the front pin (212) going through the hole (121) and inserting into the groove (131), the latching portion (211) latching in the hole (121), the rear pin (213) electrically connecting with the electrical connecting point of the PCB (3).

6. The signal conversion electrical connector (10) according to claim 5, wherein the PCB (3) further has a plurality of front electrical connecting points (32), a plurality of rear through holes (34) and a plurality of conductive terminals (33), the plurality of front electrical connecting points (32) electrically connecting with the signal conversion unit (31), the plurality of conductive terminals (33) going through the plurality of rear through holes (34) and then electrically connecting with the PCB (3) and the signal conversion unit (31).

7. The signal conversion electrical connector (10) according to claim 5, wherein the PCB (3) further has a plurality of front electrical connecting points (32) and a plurality of rear electrical connecting points (33), the front electrical connecting points (32) and the rear electrical connecting points (33) electrically connecting with the signal conversion unit (31), the rear electrical connecting points (33) electrically connecting with the conductive terminals (33).

8. The signal conversion electrical connector (10) according to claim 5, wherein the PCB (3) further has a plurality of front penetrated holes (36) and a plurality of rear penetrated holes (37), the front penetrated holes (36) and the rear penetrated holes (37) being for the pin set (2) and the conductive terminals (33) going through and then the pin set (2) and the conductive terminals (33) electrically connecting with the PCB (3) and the signal conversion unit (31).

9. The signal conversion electrical connector (10) according to claim 6 further comprising an insulated bottom plate (4), the insulated bottom plate (4) being an L-shape member and having a retaining portion (41) at a front end thereof, the retaining portion (41) having a loading portion (42) in order to load the PCB (3), the loading portion (42) having a plurality of penetrated holes (421) for the conductive terminals (33) of the PCB (3) going through, and then conductive terminals (33) electrically connecting with the main board (61) of the electronic device (6), each of two sides of the loading portion (42) having a pair of connecting portions (43) assembled with the assembling portions (15).

10. The signal conversion electrical connector (10) according to claim 9 further comprising a metal case (5), the metal case (5) having an interface (51) at a front end thereof and a flap (52) at a rear end thereof.

11. The signal conversion electrical connector (10) according to claim 10, wherein each of a top surface (53) and a bottom surface (54) of the metal case (5) has a plurality of flexible pieces (55), each of the two sides of the metal case (5) being folded to form a lateral plate (56), the lateral plate (56) extending to form a set of fixing legs (561).

12. The signal conversion electrical connector (10) according to claim 11, wherein the lateral plate (56) has a fillister (562), an open (57) being formed between the lateral plate (56) and the flap (52) and communicating with the fillister (562), the open (57) providing a connecting space for assembling with the bump (112) and the bolt (113).

13. The signal conversion electrical connector (10) according to claim 7 further comprising an insulated bottom plate (4), the insulated bottom plate (4) being an L-shape member and having a retaining portion (41) at a front end thereof, the retaining portion (41) having a loading portion (42) in order to load the printed circuit board (3), the loading portion (42) having a plurality of penetrated holes (421) for the conductive terminals (33) of the PCB (3) going through, and then conductive terminals (33) electrically connecting with the main board (61) of the electronic device (6), each of two sides of the loading portion (42) having a pair of connecting portions (43) assembled with the assembling portions (15).

14. The signal conversion electrical connector (10) according to claim 13 further comprising a metal case (5), the metal case (5) having an interface (51) at a front end thereof and a flap (52) at a rear end thereof.

15. The signal conversion electrical connector (10) according to claim 14, wherein each of a top surface (53) and a bottom surface (54) of the metal case (5) has a plurality of flexible pieces (55), each of the two sides of the metal case (5) being folded to form a lateral plate (56), the lateral plate (56) extending to form a set of fixing legs (561).

16. The signal conversion electrical connector (10) according to claim 11, wherein the lateral plate (56) has a fillister (562), an open (57) being formed between the lateral plate (56) and the flap (52) and communicating with the fillister (562), the open (57) providing a connecting space for assembling with the bump (112) and the bolt (113).

17. The signal conversion electrical connector (10) according to claim 8 further comprising an insulated bottom plate (4), the insulated bottom plate (4) being an L-shape member and having a retaining portion (41) at a front end thereof, the retaining portion (41) having a loading portion (42) in order to load the printed circuit board (3), the loading portion (42) having a plurality of penetrated holes (421) for the conductive terminals (33) of the PCB (3) going through, and then conductive terminals (33) electrically connecting with the main board (61) of the electronic device (6), each of two sides of the loading portion (42) having a pair of connecting portions (43) assembled with the assembling portions (15).

18. The signal conversion electrical connector (10) according to claim 17 further comprising a metal case (5), the metal case (5) having an interface (51) at a front end thereof and a flap (52) at a rear end thereof.

19. The signal conversion electrical connector (10) according to claim 18, wherein each of a top surface (53) and a bottom surface (54) of the metal case (5) has a plurality of flexible pieces (55), each of the two sides of the metal case (5) being folded to form a lateral plate (56), the lateral plate (56) extending to form a set of fixing legs (561).

20. The signal conversion electrical connector (10) according to claim 19, wherein the lateral plate (56) has a fillister (562), an open (57) being formed between the lateral plate (56) and the flap (52) and communicating with the fillister (562), the open (57) providing a connecting space for assembling with the bump (112) and the bolt (113).
